(19) United States
(12) Patent Application Publication
(10) Pub. No.: US 2014/0009630 A1
(43) Pub. Date: Jan. 9, 2014

(54) Automatic Photographic Device and Method thereof

(71) Applicant: WISTRON CORPORATION, New Taipei City (TW)

(72) Inventor: Wei-Chen Chang, New Taipei City (TW)

(73) Assignee: WISTRON CORPORATION, New Taipei City (TW)

(21) Appl. No.: 13/686,860

(22) Filed: Nov. 27, 2012

(30) Foreign Application Priority Data
Jul. 9, 2012 (TW) 101124597

(51) Int. Cl. H04N 5/232

(52) U.S. Cl. CPC H04N 5/23296
USPC 348/207.99

(57) ABSTRACT

An automatic photographic device for a mobile device includes a sense module for generating a sense result according to a position change of the mobile device, a determination module for generating a control signal according to the sense result, and a photographic module for processing a photographic operation according to the control signal, wherein the automatic photographic device is located within a three-dimensional space including the X-axis, the Y-axis and the Z-axis perpendicular to each other and the position change comprises a rotational angle change, a rotational velocity change and a straight acceleration change.

### BACKGROUND OF THE INVENTION

1. Field of the Invention

The present invention relates to an automatic photographic device and method, and more particularly, to an automatic photographic device and method which can process a photographic operation according to a position change of a mobile device.

2. Description of the Prior Art

Due to popularity and continuous development of mobile devices, such as the cellular phone, functions as phone dialing and multimedia messaging service (MMS) transmission have been equipped for the mobile devices. Additionally, other operations of the long-distance voice/audio communication, notebook, laptop and the digital camera have been combined with the mobile devices to satisfy users' requirements of business as well as recreation.

Since more available smart phones are in the market, mobile device vendors have developed different functional modules to attract consumers' attentions, and particularly, the photographic function is the main research focus of the mobile device vendors. As the common operation of the photographic function, physical buttons or virtual buttons disposed on a touch panel can be utilized to correspondingly turn on/off a photographic module, so as to process a photographic operation of the surrounding circumstances according to users' requirements. Under such circumstances, the user can vertically/horizontally move or rotate a camera of the mobile device, and then actively press the physical/virtual buttons to choose the proper timing and location for retrieving different pictures. However, during the photographic operation, the user may be distracted while paying more attention to press the physical/virtual buttons for retrieving the pictures, so as to accidentally move the mobile device away from the predetermined location. Certainly, the user may replace the button-touching operation with a voice control operation to correspondingly process the photographic operation of the mobile device. In that, the user generates a voice control signal to a voice recognition module for determining whether or not to process the photographic operation. Nevertheless, the voice recognition module can be easily affected by surrounding noises, which may lead to poor determination of the voice recognition module for processing the photographic operation in a proper manner.

Therefore, it has become an important issue to provide an automatic photographic device of a mobile device, which can process the photographic operation of the mobile device according to different operational manners of the users, to provide a more convenient operation for taking the pictures, so as to prevent the problems that the user may be distractive while pressing the practical/virtual buttons and accidentally moving the camera of the mobile device, or to avoid the noises being too large to correctly generate the voice control signal for the voice recognition module.

### SUMMARY OF THE INVENTION

It is therefore an objective of the invention to provide an automatic photographic device of a mobile device, which can process the photographic operation of the mobile device to prevent the user from pressing the practical/virtual buttons or recognizing the voice control signal.

An embodiment of the invention discloses an automatic photographic device for a mobile device comprising a sense module for generating a sense result according to a position change of the mobile device, a determination module for generating a control signal according to the sense result, and a photographic module for processing a photographic operation according to the control signal, wherein the automatic photographic device is located within a three-dimensional space including the X-axis, the Y-axis and the Z-axis perpendicular to each other and the position change comprises a rotational angle change, a rotational velocity change and a straight acceleration change.

An embodiment of the invention also discloses another automatic photographic method for an automatic photographic device of a mobile device, the automatic photographic method comprising generating a sense result according to a position change of the mobile device, generating a control signal according to the sense result, and processing a photographic operation according to the control signal, wherein the automatic photographic device is located within a three-dimensional space including the X-axis, the Y-axis and the Z-axis perpendicular to each other and the position change comprises a rotational angle change, a rotational velocity change and a straight acceleration change.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of an automatic photographic device according to an embodiment of the invention.

FIG. 2 illustrates a detailed schematic diagram of the sense module shown in FIG. 1 according to an embodiment of the invention.

FIG. 3 illustrates a detailed schematic diagram of the determination module shown in FIG. 1 according to an embodiment of the invention.

FIG. 4 illustrates a detailed schematic diagram of the photographic module according to an embodiment of the invention.

FIG. 5 illustrates a schematic diagram of another automatic photographic device according to an embodiment of the invention.

FIG. 6 illustrates a flow chart of an automatic photographic process according to an embodiment of the invention.

### DETAILED DESCRIPTION

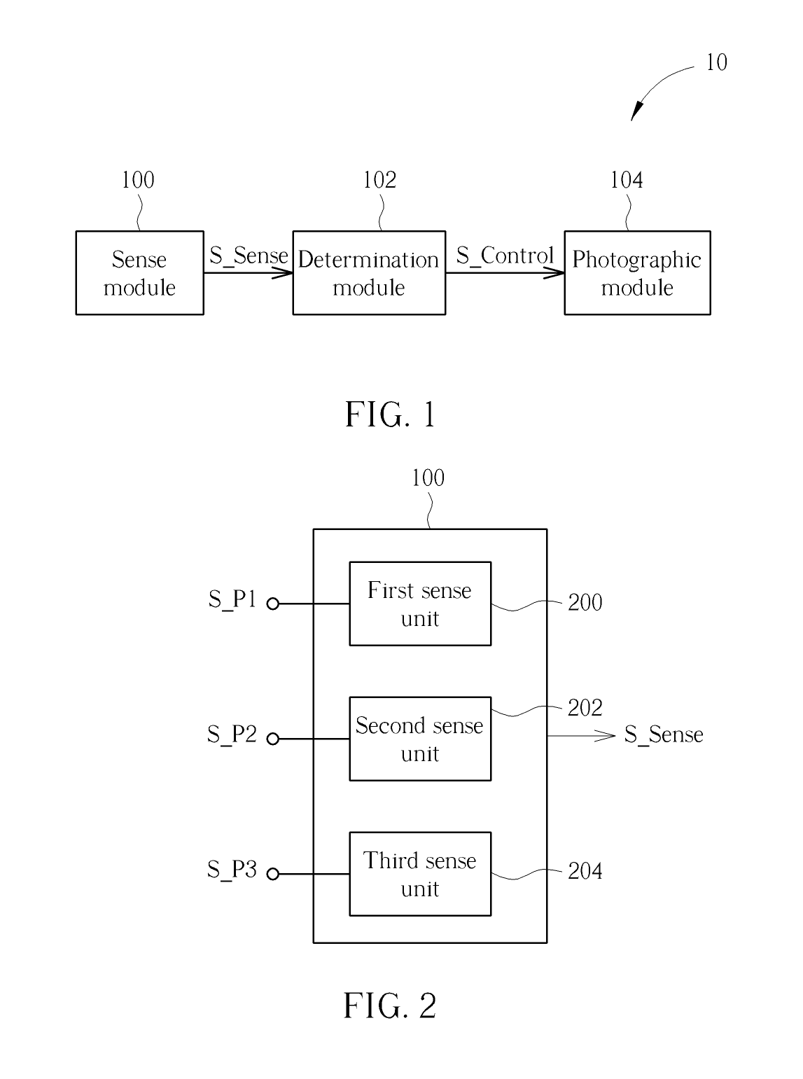

Please refer to FIG. 1, which illustrates a schematic diagram of an automatic photographic device 10 according to an embodiment of the invention. The automatic photographic device 10 is utilized in a mobile device (not shown in the figure), and conveniently, the embodiment of the invention directly integrates the automatic photographic device 10 with a smart mobile device. Certainly, those skilled in the arts can adaptively adjust disposition/connection of the automatic photographic device 10 with other mobile devices according to different requirements, which is not limited the scope of the invention.

As shown in FIG. 1, the automatic photographic device 10 includes a sense module 100, a determination module 102 and a photographic module 104. First, the sense module 100 generates a sense result S_Sense according to a position change of the mobile device. The determination module 102 is coupled to the sense module 100 and generates a control signal S_Control according to the sense result S_Sense. The photographic module 104 is coupled to the determination module 102 and processes a photographic operation of the mobile device according to the control signal S_Control, to make the mobile device take pictures within a three-dimensional space including the X-axis, the Y-axis and the Z-axis perpendicular to each other. Noticeably, the position change of the mobile device is realized as a rotational angle change, a rotational velocity change and a straight acceleration change. In comparison with the prior art via pressing the practical/virtual buttons or the voice control signal to process the photographic operation, the automatic photographic device 10 of the invention can determine whether or not to process the photographic operation for the mobile device according to the position change of the mobile device, so as to prevent the user from moving the mobile device while pressing the practical/virtual buttons or to avoid utilizing the voice control for the surrounding noises being too large to accurately process the photographic operation of the mobile device.

Please refer to FIG. 2, which illustrates a detailed schematic diagram of the sense module 100 shown in FIG. 1 according to an embodiment of the invention. As shown in FIG. 2, the sense module 100 further comprises a first sense unit 200, a second sense unit 202 and a third sense unit 204 for receiving the rotational angle change S_P1, the rotational velocity change S_P2 and the straight acceleration change S_P3 to correspondingly generate the sense result S_Sense. Noticeably, the first sense unit 200 is an orientation sensor and receives the rotational angle change S_P1 comprising an azimuth change value, a pitch change value and a roll change value. The second sense unit 202 is a gyroscope sensor and receives the rotational velocity change S_P2 comprising a X-axis rotational velocity change value, a Y-axis rotational velocity change value and a Z-axis rotational velocity change value. The third sense unit 204 is an accelerometer sensor and receives the straight acceleration change S_P3 comprising a X-axis straight acceleration change value, a Y-axis straight acceleration change value and a Z-axis straight acceleration change value.

Preferably, the azimuth change value of the rotational angle change S_P1 is obtained from rotational angle changes of the mobile device on the XY-plane referenced to the Z-axis, the pitch change value of the rotational angle change S_P1 is obtained from rotational angle changes of the mobile device on the YZ-plane referenced to the X-axis, and the roll change value of the rotational angle change S_P1 is obtained from rotational angle changes of the mobile device on the XZ-plane referenced to the Y-axis. Accordingly, the rotational angle change S_P1 is utilized to determine whether an up-down rotation or a left-right rotation is generated of the mobile device. The X-axis rotational velocity change value, the Y-axis rotational velocity change value and the Z-axis rotational velocity change value of the rotational velocity change S_P2 have the unit of radian(s) per second to define the rotational velocity change of the mobile device along the X-axis, the Y-axis and the Z-axis, so as to determine the up-down/left-right rotational velocity change of the mobile device along the X-axis, the Y-axis and the Z-axis. The X-axis straight acceleration change value, the Y-axis straight acceleration change value and the Z-axis straight acceleration change value of the straight acceleration change S_P3 define the straight acceleration change value of the mobile device along the X-axis, the Y-axis and the Z-axis to determine movements of the mobile device along the X-axis, the Y-axis and the Z-axis. Certainly, those skilled in the art can utilize similar sense elements/units for correspondingly obtaining different parameters as velocities, angles, or rotational velocities to define the position change of the mobile device, which is also in the scope of the invention.

Noticeably, the automatic photographic device 10 of the invention can process the photographic operation according to habitual operations of the user. For example, the user can arbitrarily select the object surrounding the mobile device via an optical camera (not shown in the figure) and a display panel (not shown in the figure) to correspondingly alter the position change of the mobile device, i.e. adjusting the nine parameters of the rotational angle change S_P1, the rotational velocity change S_P2 and the straight acceleration change S_P3, according to display contents of the display panel, so as to generate the sense result S_Sense of the mobile device at different time points to the determination module 102.

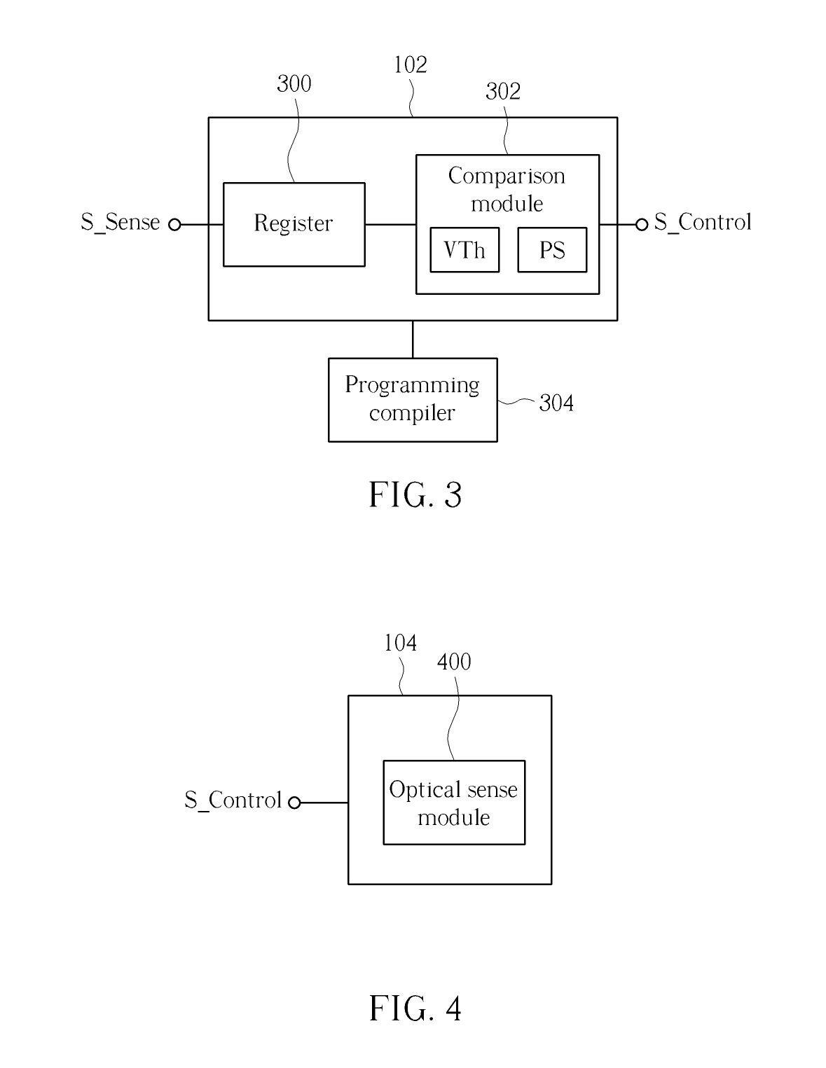

Please refer to FIG. 3, which illustrates a detailed schematic diagram of the determination module 102 shown in FIG. 1 according to an embodiment of the invention. As shown in FIG. 3, the determination module 102 further comprises a register 300 and a comparison module 302, and is coupled to a programming compiler 304 storing a programming code (not shown in the figure). Preferably, the register 300 can dynamically store the sense result S_Sense, i.e. the nine parameters of the rotational angle change S_P1, the rotational velocity change S_P2 and the straight acceleration change S_P3, at different time points according to the user's requirements. The comparison module 302 predetermines a threshold Vth and a predetermined period PS for the user to determine whether the sense result S_Sense at different time points is larger than the threshold Vth within the predetermined period PS. For example, the first sense unit 200 has a first azimuth value as 10 at a first measurement time point. After two seconds as the predetermined period PS, a second azimuth value as 15 at a second measurement time point is obtained. Under such circumstances, the user can utilize the programming code in the programming compiler 304 and the determination module 102 to obtain the azimuth value change as 5 within the predetermined period PS. In the meanwhile, the azimuth value change and the threshold Vth are compared to make the comparison module 302 generate the control signal S_Control to the photographic module 104.

Noticeably, the determination module 102 of the invention outputs the control signal S_Control according to comparison between the threshold Vth and the nine parameters of the rotational angle change S_P1, the rotational velocity change S_P2 and the straight acceleration change S_P3 within the predetermined period PS. Under such circumstances, the user can utilize the programming code in the programming compiler 304 to adaptively modify/adjust values of the threshold Vth and the predetermined period PS, so as to comply with different requirements. Besides, the control signal S_Control further comprises a photographic signal and a waiting signal. If the sense result S_Sense is not larger than the threshold Vth within the predetermined period PS, the determination module 102 outputs the photographic signal to the photographic module 104 for processing the photographic operation. If sense result S_Sense is larger than the threshold Vth within the predetermined period PS, the determination module 102 outputs the waiting signal to stop processing photographic operation of the photographic module 104.

In other words, the embodiment of the invention detects the position change of the mobile device to determine whether the user utilizes the photographic module 104 to focus on a particular object surrounding the mobile device. If the user has focused on the particular object surrounding the mobile device for awaiting period (i.e. the predetermined period PS), the automatic photographic device 10 processes the photographic operation. On the contrary, if the user has not focused on the particular object surrounding the mobile device for the waiting period (i.e. the predetermined period PS), values of the position change of the mobile device may significantly change to stop the automatic photographic device 10 processing the photographic operation. Until the user stops moving the mobile device, the photographic operation will be processed. Preferably, the automatic photographic device 10 can dynamically determine whether or not to process the photographic operation of the mobile device according to the photographic signal and the waiting signal. Certainly, those skilled in the art can combine other photographic mechanisms compiled as another programming code in the programming compiler 304 to represent different photographic circumstantial modes, or cooperate with another circumstantial signal corresponding to a particular position change to process a circumstantial photographic operation, which is also in the scope of the invention.

Please refer to FIG. 4, which illustrates a detailed schematic diagram of the photographic module 104 according to an embodiment of the invention. As shown in FIG. 4, the photographic module 104 further comprises an optical sense module 400. The optical sense module 400 is realized as an optical-sensed transistor element combining at least an optical lens, and is not limited hereinafter. The photographic module 104 receives the control signal S_Control to determine whether or not to process the photographic operation. Preferably, the photographic operation at least comprises a shutter operation, an aperture operation and an international standards organization (ISO) operation, to correspondingly process the (optical) auto-focusing, the white balance adjustment or other optical compensation operations. Moreover, the above operations can also be compiled as another programming code, to cooperate with the programming code stored in the programming compiler 304 or the programming codes for the photographic circumstantial modes, which is also in the scope of the invention.

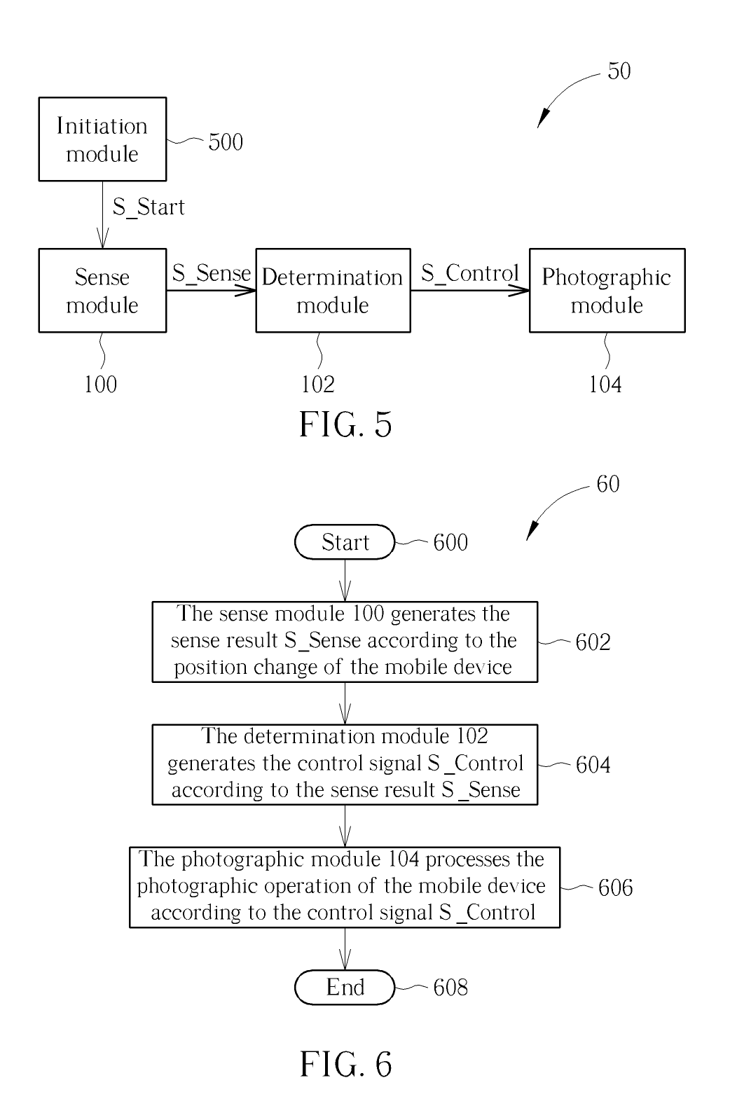

Please refer to FIG. 5, which illustrates a schematic diagram of another automatic photographic device 50 according to an embodiment of the invention. As shown in FIG. 5, the automatic photographic device 50 further comprises an initiation module 500 coupled to the sense module 100, so as to cooperate with a practical/virtual button installed on the mobile device. If the user wants to process the photographic operation of the automatic photographic device 50, he (she) can press the practical/virtual button to generate an initiation signal S_Start, so as to initiate the photographic operation of the automatic photographic device 50. The detailed operations of the automatic photographic device 50 are similar to the automatic photographic device 10, which is not described hereinafter. In simple, the user can simultaneously utilize the automatic photographic devices 10, 50 and the photographic operation of the conventional camera, which can be adaptively switched via the initiation module 500, to broaden the application range of the automatic photographic devices 10, 50.

Further, the operations of the automatic photographic devices 10, 50 can be summarized as an automatic photographic process 60, as shown in FIG. 6. The automatic photographic process 60 includes the steps as follows.

Step 600: Start.

Step 602: The sense module 100 generates the sense result S_Sense according to the position change of the mobile device.

Step 604: The determination module 102 generates the control signal S_Control according to the sense result S_Sense.

Step 606: The photographic module 104 processes the photographic operation of the mobile device according to the control signal S_Control.

Step 608: End

The detailed operations of the automatic photographic process 60 can be understood from the automatic photographic devices 10, 50, FIG. 1 to FIG. 5 and related paragraphs thereof, which is not described hereinafter. Noticeably, the automatic photographic process 60 can be adaptively compiled as another programming code to be pre-stored in another programming compiler, which is also coupled to the automatic photographic devices 10, 50 or the programming compiler 304 to further control the operations of the automatic photographic devices 10, 50. Certainly, those skilled in the art can modify/change the operations of the embodiment to utilize other sense units/elements for obtaining the position change of the mobile device rather than being limited by the nine parameters of the rotational angle change S_P1, the rotational velocity change S_P2 and the straight acceleration change S_P3, so as to accomplish the photographic operation for the user, i.e. the user can process the photographic operation via simply stabilizing the position of the mobile device for a short period, which is also in the scope of the invention.

In summary, the invention provides an automatic photographic device and method for a mobile device. Through a sense module to determine a position change of the mobile device, a determination module can generate a control signal to drive a photographic module for processing a photographic operation. Due to utilization of at least nine parameters detected by at least three sense units, the photographic operation within a predetermined period can be processed to prevent the user, in the prior art, from moving the mobile device while pressing practical/virtual buttons or encountering too large surrounding noises to accurately process the voice control, so as to broaden the application range of the mobile device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic photographic device for a mobile device, comprising:
a sense module for generating a sense result according to a position change of the mobile device;
a determination module for generating a control signal according to the sense result; and
a photographic module for processing a photographic operation according to the control signal;
wherein the automatic photographic device is located within a three-dimensional space including the X-axis, the Y-axis and the Z-axis perpendicular to each other and the position change comprises a rotational angle change, a rotational velocity change and a straight acceleration change.

2. The automatic photographic device of claim 1, wherein the sense module further comprises a first sense unit, a second sense unit and a third sense unit for generating the sense result according to the rotational angle change, the rotational velocity change and the straight acceleration change, respectively.

3. The automatic photographic device of claim 2, wherein the first sense unit is an orientation sensor, and the rotational angle change comprises an azimuth change value, a pitch change value and a roll change value.

4. The automatic photographic device of claim 2, wherein the second sense unit is a gyroscope sensor, and the rotational velocity change comprises a rotational velocity change value along the X-axis, the Y-axis or the Z-axis.

5. The automatic photographic device of claim 2, wherein the third sense unit is an accelerometer sensor, and the straight acceleration change comprises a straight acceleration change value along the X-axis, the Y-axis or the Z-axis.

6. The automatic photographic device of claim 1, wherein the determination module further comprises a register for storing a plurality of sense results corresponding to a plurality of time points.

7. The automatic photographic device of claim 6, wherein the determination module further comprises a comparison module for comparing the plurality of sense results corresponding to the plurality of time points, so as to generate the control signal.

8. The automatic photographic device of claim 7, wherein the comparison module further predetermines a threshold and a predetermined period for comparing whether differences between the plurality of sense results corresponding to the plurality of time points are larger than the threshold within the predetermined period.

9. The automatic photographic device of claim 8, wherein when the differences between the plurality of sense results corresponding to the plurality of time points are not larger than the threshold within the predetermined period, the determination module generates the control signal to make the photographic module process the photographic operation.

10. The automatic photographic device of claim 1, wherein the photographic operation comprises a shutter operation, an aperture operation and an international standards organization operation, and at least an optical sense module is utilized for obtaining an image data corresponding to the mobile device.

11. An automatic photographic method for an automatic photographic device of a mobile device, the automatic photographic method comprising:
generating a sense result according to a position change of the mobile device;
generating a control signal according to the sense result; and
processing a photographic operation according to the control signal;
wherein the automatic photographic device is located within a three-dimensional space including the X-axis, the Y-axis and the Z-axis perpendicular to each other and the position change comprises a rotational angle change, a rotational velocity change and a straight acceleration change.

12. The automatic photographic method of claim 11, further utilizing a first sense unit, a second sense unit and a third sense unit for generating the sense result according to the rotational angle change, the rotational velocity change and the straight acceleration change, respectively.

13. The automatic photographic method of claim 12, further utilizing the first sense unit to sense an azimuth change value, a pitch change value and a roll change value.

14. The automatic photographic method of claim 12, further utilizing the second sense unit to sense a rotational velocity change value along the X-axis, the Y-axis or the Z-axis.

15. The automatic photographic method of claim 12, further utilizing the third sense unit to sense a straight acceleration change value along the X-axis, the Y-axis or the Z-axis.

16. The automatic photographic method of claim 11, further utilizing register for storing a plurality of sense results corresponding to a plurality of timing points.

17. The automatic photographic method of claim 16, further utilizing a comparison module for comparing the plurality of sense results corresponding to the plurality of time points, so as to generate the control signal.

18. The automatic photographic method of claim 17, further comparing whether differences between the plurality of sense results corresponding to the plurality of time points are larger than a threshold within a predetermined period.

19. The automatic photographic method of claim 18, wherein when the differences between the plurality of sense results corresponding to the plurality of time points are not larger than the threshold within the predetermined period, the control signal is correspondingly generated to process the photographic operation.

20. The automatic photographic method of claim 11, wherein the photographic operation comprises a shutter operation, an aperture operation and an international standards organization operation, and at least an optical sense module is utilized for obtaining an image data corresponding to the mobile device.
